(19) United States
(12) Patent Application Publication
(10) Pub. No.: US 2010/0271997 A1
(43) Pub. Date: Oct. 28, 2010

(54) Apparatus for Dynamically Adjusting a Power Amplifier of a Mobile Terminal

(75) Inventors: Yuqiang Lai, Guangdong Province (CN); Jianhua Mao, Guangdong Province (CN); Tianbo Du, Guangdong Province (CN)

Correspondence Address: WALKER & JOCKE, L.P.A., 231 SOUTH BROADWAY STREET, MEDINA, OH, 44256, US

(73) Assignee: ZTE CORPORATION, Shenzhen, Guangdong (CN)

(21) Appl. No.: 12/810,512

(22) PCT Filed: Dec. 25, 2007
(86) PCT No.: PCT/CN2007/003781

§ 371 Date: Jun. 24, 2010

(51) Int. Cl. H04W 52/02

(52) U.S. Cl. 370/311

(57) ABSTRACT

An apparatus for dynamically adjusting a power amplifier of a mobile terminal is provided by the present invention, the apparatus includes: a controlling unit, adapted to receive a dynamically varying control signal from a base band chip and control a voltage adjusting unit according to the control signal; the voltage adjusting unit, adapted to dynamically adjust a power supply voltage and a bias voltage of a radio frequency, RF, power amplifying unit under the control of the controlling unit in the case of the mobile terminal being in a transmitting state; and the RF power amplifying unit, adapted to work under the power supply voltage and the bias voltage and to amplify the power of modulated OFDM signal With the present invention, the following problems and disadvantages of the linear power amplifier are overcome: due to the fixed bias and power supply voltage, the efficiency is low and the power consumption is high in the case of a medium or small power output and the linearity does not satisfy the requirement due to a low power supply voltage in the case of large power output.

### FIELD OF THE INVENTION

The present invention relates to communication field, in particular to an apparatus for dynamically adjusting a power amplifier of a mobile terminal.

### BACKGROUND OF THE INVENTION

With the rapid development of the communication technology and the network technology, wireless wideband access technologies have become mature, the 4G Worldwide Interoperability for Microwave Access (WiMAX) is a best representative of such technology, while strict requirement is imposed on the power consumption reduction of the mobile terminal, especially the reduction of the power consumption of radio frequency linear power amplifier.

Due to the particularity of the Orthogonal Frequency Division Multiplexing (OFDM) technology, which imposes a strict index requirement on the linearity of the power amplifier. For example, current WiMAX system employs Time Division Duplex (TDD) mode, upon receiving the power amplifier of the terminal is only applied with power supply voltage without bias voltage, thus there is a very small leakage current. The bias is added under the control of a base band chip only at the time of transmission. Due to the miniaturization of the terminals, in order to guarantee the linearity of the power amplifier, the power amplifier is made to work only in type A or type AB, without employing other complex linearity technology. The power consumption in the case of fixed bias and fixed power supply voltage is often quite high. In related field, under the circumstance of the linearity being guaranteed, the efficiency of the power amplifier is about 18% at the largest output power, and about 10% at a lower output power, which means that large amount of energy is consumed, and the use time of battery is reduced. Even in a PC or a notebook computer, due to the large current, the specification related to the USB will not be satisfied.

There is a known technology which adjusts the bias of the power amplifier using a structure having a wave detector and a current-voltage converter, but its structure is complex.

There is another known technology which adaptively adjusts the bias of the power amplifier according to the Peak to Average Power Ratio (PAPR) of the transmitted signal, modulation information, and signal quality of the communication system, but it has a complex structure, and is supported by an algorithm.

### SUMMARY OF THE INVENTION

In viewing of one or more problems mentioned above, the present invention proposes an apparatus for dynamically adjusting a power amplifier of a mobile terminal, which dynamically adjusts the bias and power supply voltage of the RF amplifier according to the power magnitude of the modulated OFDM signal being input, in the condition that the output power and the linearity of the power amplifier required by the modulated OFDM signal are satisfied (for the power amplifier supplied with a single power supply, only the power supply voltage is adjusted), so as to guarantee that there is a comparatively high additional efficiency for all input signals to realize the purpose of reducing power consumption, which is suitable for both Frequency Division Duplex (FDD) and TDD modes.

The apparatus for dynamically adjusting a power amplifier of a mobile terminal according to the embodiment of the present invention comprises: a controlling unit, adapted to receive a dynamically varying control signal from a base band chip and control a voltage adjusting unit according to the control signal; an voltage adjusting unit, adapted to dynamically adjust a power supply voltage and a bias voltage of a radio frequency, RF, power amplifying unit under the control of the controlling unit in the case of the mobile terminal being in a transmitting state; and the RF power amplifying unit, adapted to work under the power supply voltage and the bias voltage and to amplify the power of modulated OFDM signal.

Wherein, the controlling unit comprises: a receiving unit, adapted to receive the control signal from the base band chip; a converting unit, adapted to convert the control signal into a continuously varying analog voltage signal and a switch signal for controlling the on and the off of the voltage adjusting unit; and a sending unit, adapted to send the analog voltage signal and the switch signal to the voltage adjusting unit.

The voltage adjusting unit comprises: an adjusting unit, adapted to dynamically adjust the power supply voltage and the bias voltage of the RF power amplifying unit according to the analog voltage signal; and a switching unit, adapted to switch on or off the voltage adjusting unit according to the switch signal.

When the mobile terminal is in a sleep mode or an idle mode, the voltage adjusting unit is in the off state under the control of the controlling unit. When the mobile terminal is in the receiving state, the voltage adjusting unit is in the on state and outputs a predetermined power supply voltage to the RF power amplifying unit under the control of the controlling unit. When the mobile terminal has completed the transmission, the voltage adjusting unit is in the on state and maintains the power supply voltage in the transmission state under the control of the controlling unit.

With the present invention, the following problems and disadvantages of the linear power amplifier are overcome: due to the fixed bias and power supply voltage, the efficiency is low and the power consumption is high in the case of a medium or small power output and the linearity does not satisfy the requirement due to a low power supply voltage in the case of large power output.

### BRIEF DESCRIPTION OF THE DRAWINGS

Drawings are provided for the further understanding of the present invention and form a part of the specification, which are used to explain the present invention with the embodiments of the present invention rather than limit the present invention, wherein,

FIG. 1 is the block diagram showing the apparatus for dynamically adjusting the power amplifier according to the embodiment of the present invention;

FIG. 2 is the flow chart showing the process method of the apparatus for dynamical adjusting the power amplifier according to the embodiment of the present invention; and

FIG. 3 is the flow chart showing the achieving process of dynamic adjustment of the apparatus according to the embodiment of the present invention.

### DETAILED DESCRIPTION OF THE EMBODIMENTS

The specific implementation of the present invention is described in detail hereinafter with reference to the drawings.

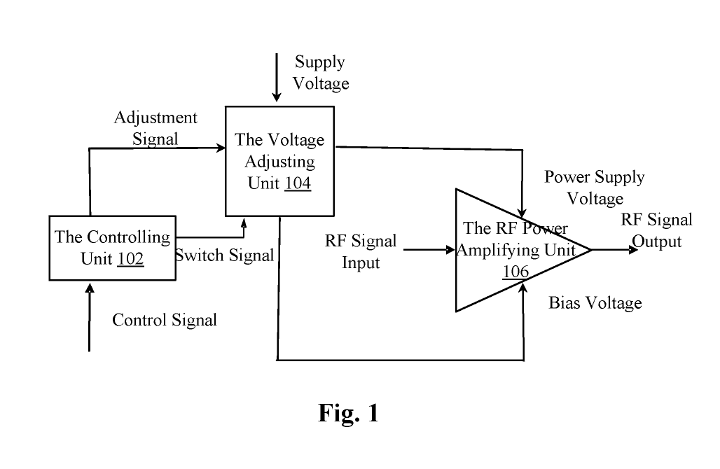

FIG. 1 is the block diagram showing the apparatus for dynamically adjusting the power amplifier according to an embodiment of the present invention. As shown in FIG. 1, the apparatus comprises: a controlling unit 102, which is adapted to receive a dynamically varying control signal from a base band chip and control a voltage adjusting unit according to the control signal; the voltage adjusting unit 104, which is adapted to dynamically adjust a power supply voltage and a bias voltage of a RF power amplifying unit under the control of the controlling unit in the case of the mobile terminal being in a transmitting state; and the RF power amplifying unit 106, which is adapted to work under the power supply voltage and the bias voltage and to amplify the power of modulated OFDM signal

Wherein, the controlling unit 102 comprises: a receiving unit, which is adapted to receive the control signal from the base band chip; a converting unit, which is adapted to convert the control signal into a continuously varying analog voltage signal and a switch signal for controlling the on and the off of the voltage adjusting unit; and a sending unit, which is adapted to send the analog voltage signal and the switch signal to the voltage adjusting unit.

The voltage adjusting unit 104 comprises: an adjusting unit, which is adapted to dynamically adjust the power supply voltage and the bias voltage of the RF power amplifying unit according to the analog voltage signal; and a switching unit, which is adapted to switch on or off the voltage adjusting unit according to the switch signal.

When the mobile terminal is in a sleep mode or an idle mode, the voltage adjusting unit is in the off state under the control of the controlling unit. When the mobile terminal is in the receiving state, the voltage adjusting unit is in the on state and outputs a predetermined power supply voltage to the RF power amplifying unit under the control of the controlling unit. When the mobile terminal has completed the transmission, the voltage adjusting unit is in the on state and maintains the power supply voltage in the transmission state under the control of the controlling unit.

In particular, the relationship of the controlling unit, the voltage adjusting unit and the RF power amplifying unit is that the controlling unit converts the digital signal output by the base band chip into a continuously varying analog voltage signal and a switch signal, wherein the switch signal controls the on and the off of the voltage adjusting unit, the analog voltage signal adjusts the bias voltage and the power supply voltage output by the voltage adjusting unit, and the RF power amplifying unit is used to amplify the modulated OFDM signal (WiMAX signal).

The bias method of the apparatus for dynamically adjusting the power amplifier according to the present invention comprises the following steps:

Step 1, the controlling unit is controlled by the base band chip, and outputs a corresponding voltage to the voltage adjusting unit.

Step 2, the voltage adjusting unit outputs a power supply voltage and a bias voltage to the RF power amplifying unit.

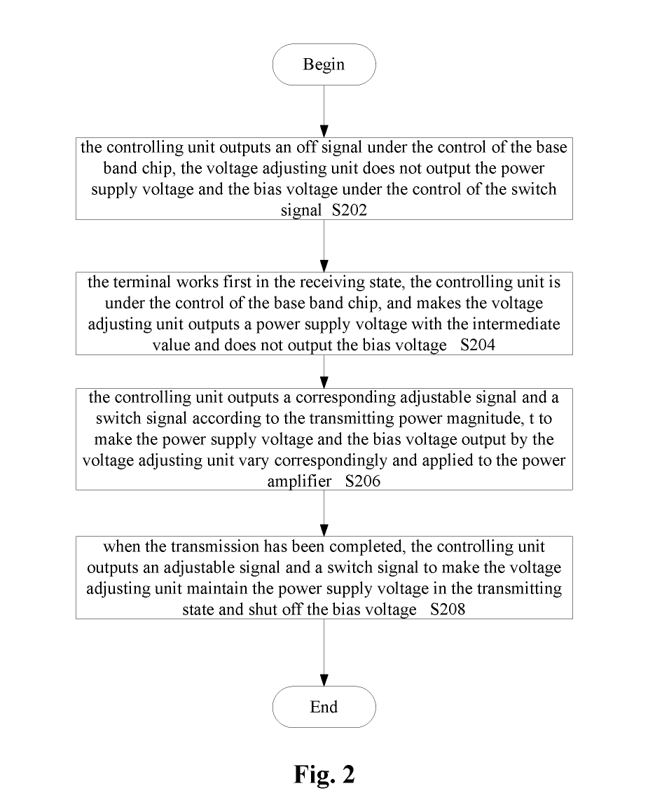

FIG. 2 is the flow chart showing the process method of the apparatus for dynamically adjusting the power amplifier according to an embodiment of the present invention. As shown in FIG. 2, the process method comprises the following steps:

Step S202, when the mobile terminal is in the sleep mode or the idle mode, the controlling unit is under the control of the control signal output by the base band chip, and outputs a switch signal and an adjustment signal to the voltage adjusting unit, the voltage adjusting unit does not output under the control of the switch signal of the controlling unit, at this point, the power amplifier is in the zero power consumption state.

Step S204, when the terminal is in the work state, and it is first in the receiving state. The controlling unit first presets an intermediate value to control the voltage adjusting unit to output a power supply voltage with the intermediate value, the intermediate value is determined according to the particular application and the RF power amplifier, but the output switch signal makes the voltage adjusting unit output a voltage without the bias voltage. At this point, the RF power amplifier has only a little leakage current and is in a low power consumption state.

Step S206, when in the transmitting state, the terminal determines the transmitting power magnitude and outputs a corresponding control signal to the controlling unit according to close loop power control algorithm (which is determined by the base station and the terminal together, and the function is supported by current base band chips).At the same time, the controlling unit outputs the switch signal and the adjustment signal, wherein the switch signal switches on the bias voltage output, and the adjustment signal makes the voltage adjusting unit output the corresponding power supply voltage and the bias voltage applied to the RF power amplifier.

Step S208, when the transmission has been completed, the controlling unit outputs the adjustment signal and the switch signal according to the base band control signal to make the voltage adjusting unit maintain the power supply voltage in the transmission state and shut off the bias voltage.

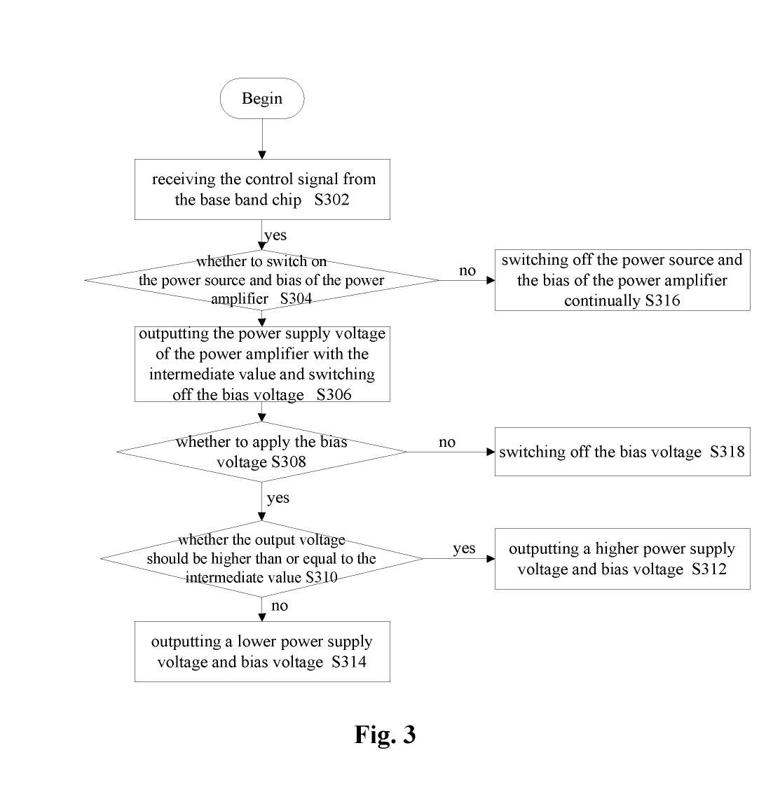

FIG. 3 is the flow chart showing the realization of dynamic adjustment of the apparatus according to an embodiment of the present invention. As shown in FIG. 3, the dynamic adjustment comprises the following steps:

Step S302, receiving the control signal from the base band chip.

Step S304, judging whether to switch on the power source of the power amplifier according to the control signal from the base band chip, and if yes, the process goes to Step S306, or else goes to Step S316.

Step S306, outputting the power supply voltage with the intermediate value, and shutting off the bias voltage.

Step S308, judging whether the bias voltage is applied, if yes, the process goes to Step S310, or else goes to Step S318.

Step S310, judging whether the power supply voltage should be higher than or equal to the intermediate value, if yes, the process goes to Step S312, or else goes to Step S314.

Step S312, outputting a higher power supply voltage and the bias voltage.

Step S314, outputting a lower power supply voltage and the bias voltage.

Step S316, shutting off the power source and the bias of the power amplifier continually.

Step S318, shutting off the bias voltage continually.

When the WiMAX terminal is transmitting, the base band chip adjusts the transmitting power magnitude timely according to the open loop or the close loop power control algorithms (currently, all the WiMAX base band chips support such algorithms), and dynamically changes the control signal magnitude according to the transmitting power magnitude, uses the control signal to control the power source and the bias circuit unit to make its output power supply voltage and the bias voltage vary with the transmitting power magnitude, when the transmitting power is high, the power supply voltage and the bias voltage are correspondingly increased, while the transmitting power is low, the power supply voltage and the bias voltage is correspondingly reduced.

By the present invention, when the terminal is transmitting, the base band chip adjusts the transmitting power magnitude timely according to the open loop or the close loop power control algorithms (currently, all the base band chips support such algorithms), dynamically changes the control signal magnitude according to the transmitting power magnitude, and uses the control signal to control the power source and the bias circuit unit to make its output power supply voltage and the bias voltage vary with the transmitting power magnitude.

Above description is to illustrate the preferred embodiments not limit the present invention. Various alterations and changes to the present invention are apparent to those skilled in the art. The scope defined in claims shall comprise any modification, equivalent substitution and improvement in the spirit and principle of the present invention.

1. An apparatus for dynamically adjusting a power amplifier of a mobile terminal, comprising:
a controlling unit, adapted to receive a dynamically varying control signal from a base band chip and control a voltage adjusting unit according to the control signal;
the voltage adjusting unit, adapted to dynamically adjust a power supply voltage and a bias voltage of a radio frequency, RF, power amplifying unit under the control of the controlling unit in the case of the mobile terminal being in a transmitting state; and
the RF power amplifying unit, adapted to work under the power supply voltage and the bias voltage and to amplify the power of modulated OFDM signal.

2. The apparatus for dynamically adjusting a power amplifier of a mobile terminal according to claim 1, wherein the controlling unit comprises:
a receiving unit, adapted to receive the control signal from the base band chip;
a converting unit, adapted to convert the control signal into a continuously varying analog voltage signal and a switch signal for controlling the on and the off of the voltage adjusting unit; and
a sending unit, adapted to send the analog voltage signal and the switch signal to the voltage adjusting unit.

3. The apparatus for dynamically adjusting a power amplifier of a mobile terminal according to claim 2, wherein the voltage adjusting unit comprises:
an adjusting unit, adapted to dynamically adjust the power supply voltage and the bias voltage of the RF power amplifying unit according to the analog voltage signal; and
a switching unit, adapted to switch on or off the voltage adjusting unit according to the switch signal.

4. The apparatus for dynamically adjusting a power amplifier of a mobile terminal according to claims 1, wherein when the mobile terminal is in a sleep mode or an idle mode, the voltage adjusting unit is in the off state under the control of the controlling unit.

5. The apparatus for dynamically adjusting a power amplifier of a mobile terminal according to claims 2, wherein when the mobile terminal is in a sleep mode or an idle mode, the voltage adjusting unit is in the off state under the control of the controlling unit.

6. The apparatus for dynamically adjusting a power amplifier of a mobile terminal according to claims 3, wherein when the mobile terminal is in a sleep mode or an idle mode, the voltage adjusting unit is in the off state under the control of the controlling unit.

7. The apparatus for dynamically adjusting a power amplifier of a mobile terminal according to claim 1, wherein when the mobile terminal is in the receiving state, the voltage adjusting unit is in the on state and outputs a predetermined power supply voltage to the RF power amplifying unit under the control of the controlling unit.

8. The apparatus for dynamically adjusting a power amplifier of a mobile terminal according to claims 2, wherein when the mobile terminal is in the receiving state, the voltage adjusting unit is in the on state and outputs a predetermined power supply voltage to the RF power amplifying unit under the control of the controlling unit.

9. The apparatus for dynamically adjusting a power amplifier of a mobile terminal according to claims 3, wherein when the mobile terminal is in the receiving state, the voltage adjusting unit is in the on state and outputs a predetermined power supply voltage to the RF power amplifying unit under the control of the controlling unit.

10. The apparatus for dynamically adjusting a power amplifier of a mobile terminal according to claim 1, wherein when the mobile terminal has completed the transmission, the voltage adjusting unit is in the on state and maintains the power supply voltage in the transmission state under the control of the controlling unit.

11. The apparatus for dynamically adjusting a power amplifier of a mobile terminal according to claim 2, wherein when the mobile terminal has completed the transmission, the voltage adjusting unit is in the on state and maintains the power supply voltage in the transmission state under the control of the controlling unit.

12. The apparatus for dynamically adjusting a power amplifier of a mobile terminal according to claim 3, wherein when the mobile terminal has completed the transmission, the voltage adjusting unit is in the on state and maintains the power supply voltage in the transmission state under the control of the controlling unit.

13. A method for dynamically adjusting a power amplifier of a mobile terminal, comprising:
step 1, receiving a dynamically varying control signal from a base band chip;
step 2, dynamically adjusting a power supply voltage and a bias voltage of a radio frequency, RF, power amplifier according to the dynamically varying control signal in the case of the mobile terminal being in a transmitting state; and
step 3, amplifying the power of modulated OFDM signal under the power supply voltage and the bias voltage.

14. The method for dynamically adjusting a power amplifier of a mobile terminal according to claim 13, wherein step 1 comprises:
step 11, receiving the control signal from the base band chip;
step 12, converting the control signal into a continuously varying analog voltage signal and a switch signal for controlling the on and the off of the voltage adjusting; and
step 13, sending the analog voltage signal and the switch signal.

15. The method for dynamically adjusting a power amplifier of a mobile terminal according to claim 14, wherein step 2 comprises:
step 21, dynamically adjusting the power supply voltage and the bias voltage of the RF power amplifier according to the analog voltage signal; and
step 22, switching on or off the voltage adjusting according to the switch signal.

16. The method for dynamically adjusting a power amplifier of a mobile terminal according to any one of claim 13, wherein when the mobile terminal is in a sleep mode or an idle mode, the voltage adjusting is in the off state.

17. The method for dynamically adjusting a power amplifier of a mobile terminal according to any one of claim 13, wherein when the mobile terminal is in the receiving state, the voltage adjusting is in the on state and outputs a predetermined power supply voltage to the RF power amplifier.

18. The method for dynamically adjusting a power amplifier of a mobile terminal according to any one of claim 13, wherein when the mobile terminal has completed the transmission, the voltage adjusting is in the on state and maintains the power supply voltage in the transmission state.
